(19) United States
(12) Patent Application Publication
(10) Pub. No.: US 2002/0075697 A1
(43) Pub. Date: Jun. 20, 2002

(54) Glittering artificial jewelry

(76) Inventor: Man Kuen Lam, North Point (HK)

Correspondence Address: RABIN & CHAMPAGNE, P.C., Suite 500, 1101 14th Street, N.W., Washington, DC, 20005, US

(21) Appl. No.: 09/883,914

(22) Filed: Jun. 20, 2001

(30) Foreign Application Priority Data
Oct. 27, 2000 (CN) 00262655.1

(51) Int. Cl. F21S 4/00

(52) U.S. Cl. 362/571

(57) ABSTRACT

A kind of artificial jewelry being able to emit a glittering light is characterized in that it comprises two shell bodies encompassing a set of inner works fixed in it. Said inner works comprise a circuit board on which are mounted button cells, sensitive snap switch and light emitting diode connected by wiring. When the glittering artificial jewelry of the present invention is being worn on human body. The sensitive snap switch within it would in response to the movements of human body intermittently connects with the power source to make the light emitting diode emit a glittering light, forming a fresh dynamic feeling of dazzling brightness and creating a lively atmosphere full of vitality for the recreational places.

### FIELD OF THE INVENTION

The present invention relates to artificial jewelry, in particular, a kind of glittering artificial jewelry.

### BACKGROUND OF THE INVENTION

The jewelry indicated here involves jewelry that people wear on them, for example, necklace, handchain, anklet, bracelet, ring, earring, pin, brooch, headwear, pin, and pendant, etc. The purpose of wearing these jewelry is no more than to show themselves off, to display their wealth and to make them with dazzling brightness so as to fascinate and enchant people. However, the so-called “dazzling brightness” effects of the jewelry set with pearl or gem are rather limited, notwithstanding that the cost of the jewelry is very high. Most of the jewelry are not luminous by themselves, even the reflecting power of some of them is not high. Therefore, the true realization of dazzling brightness would be affected by many environmental factors.

The object of the present invention is to overcome the deficiencies of the natural jewelry by providing a kind of glittering artificial jewelry, to enhance the merry atmosphere in dancing hall, restaurant, night club, bar and family party, adds it a dynamic feeling of truly dazzling brightness and set off by shading a humane environment full of vitality.

The object of the present invention is realized as follows. A glittering artificial jewelry is characterized in that the shell of the jewelry encompasses a set of inner works fixed in it, said inner works comprising a circuit board with button cells, sensitive snap switch and light emitting diode mounted on it and connected by wiring;

### SUMMARY OF THE INVENTION

The circuit of the inner works further including a slide switch, when glittering of the jewelry is not wanted, the power supply can be cut off to save energy;

The circuit of the inner works further including a delay circuit composed of a resistor R1, a capacitor C1, a resistor R2 and a triode Q1;

Two semi-shell bodies A and B are inlaid by a Ω-shaped removable or fixed hinge joint, the removable hinge joint is attached by means of cassava glue, while the fixed hinge joint is joined by screws, the removable hinge joint being made of polystyrene to make the two semi-shell bodies open easily;

Shell body A is the top shell having a window for the light emitting diode on it, and shell body B is the base shell having a ring for being worn on the finger;

Shell bodies A and B are each a semi-shell body made of transparent frosted colloid.

As the inner works of the present invention is mainly composed of sensitive snap switch, light emitting diode and cells, the sensitive snap switch in pace with the jumping, dancing for joy of people intermittently connects with the power supply to make the light emitting diode emit a glittering light, and to form a dynamic feeling of dazzling brightness, and creating a lively atmosphere full of vitality for the dancing hall, restaurant, night club, bar as well as family activities.

### BRIEF DESCRIPTION OF THE DRAWING

The following is a further description of the present invention incorporated with embodiments and with reference to the accompanying drawings.

FIG. 1 is an exploded perspective diagram of embodiment I—a glittering ring of the present invention.

FIG. 2 is an exploded perspective diagram of embodiment II—a glittering neck pendant of the present invention.

FIG. 3 is a perspective diagram of an assembly of the inner works in FIG. 2.

FIG. 4 is a circuit diagram of the present invention.

FIG. 5 is another circuit diagram of the present invention.

In the drawings:

| | |
|---|---|
| 1-shell body A, the top shell | 11-window for light emitting diode |
| 2-inner works | 21-slide switch |
| 22-light emitting diode | 23-screws |
| 24-sensitive snap switch | 25-cells fixing plate |
| 26-circuit board | 27-button cells |
| 28-cell box | 3-shell body B, the base shell |
| 31-removable hinge joint | 32-ring |
| 33-hanging ring | |

### DETAILED DESCRIPTION OF THE INVENTION

The glittering artificial jewelry of the present invention certainly includes necklace, handchain, anklet, bracelet, ring, earring, pin, brooch, headwear pin, pendant etc. The basic principle is that a set of inner works is installed within the shell body of the above-mentioned jewelries, that's all. The fundamental structure of the inner works mainly comprises a circuit board which can be encompassed within the shell body, on which circuit board are mounted cells, a sensitive snap switch and a light emitting diode with appropriate wiring connecting therethrough. The construction and working principle of the present invention will be described in detail with reference to the glittering ring and the glittering neck pendant as examples.

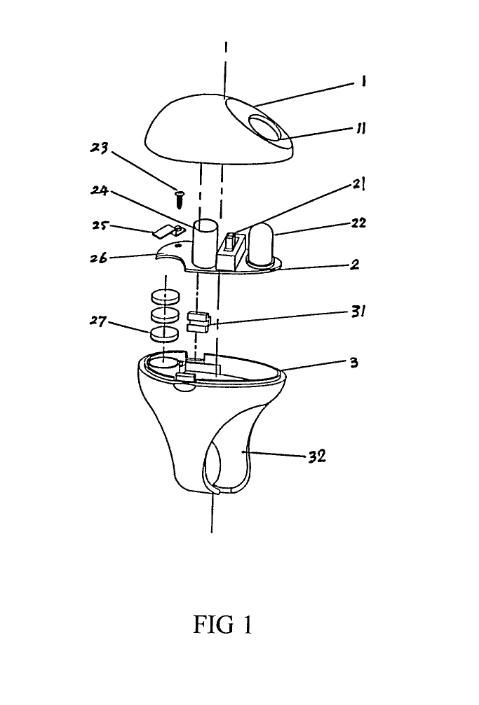

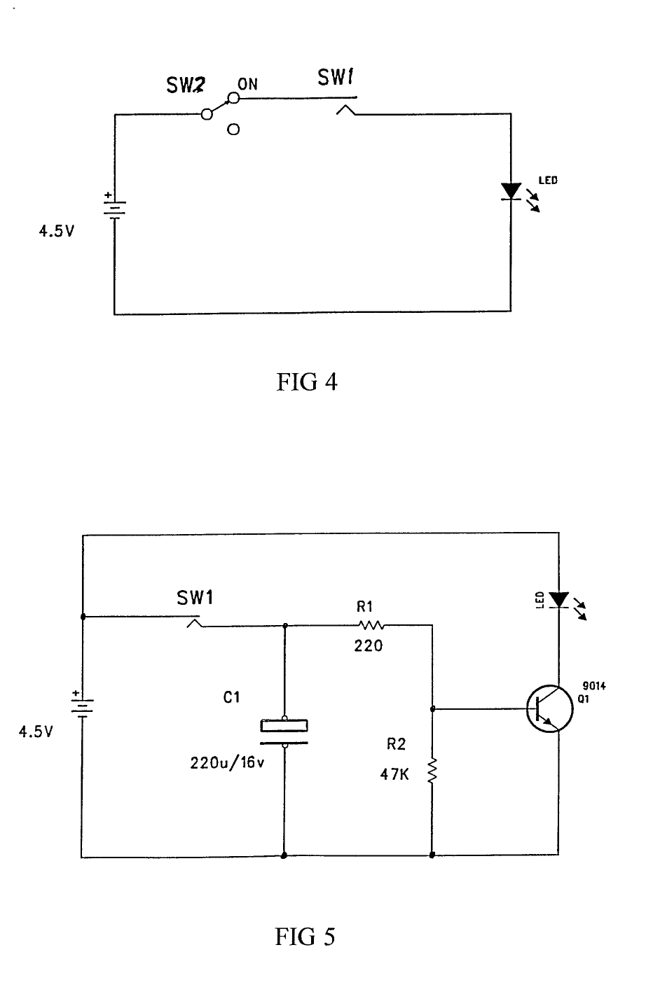

FIG. 1 is an exploded perspective diagram of embodiment I—a glittering ring of the present invention. It is composed of three parts, namely, a top shell 1, inner works 2 and a base shell 3. The top shell 1 has a window for the light emitting diode 11 and the base shell 3 has a ring 32 thereon. The top shell 1 and base shell 3 are inlaid by a Ω shaped removable hinge joint, the removable hinge joint being made of polystyrene to ensure easy opening of top shell 1 and base shell 3. Said works 2 comprises a circuit board 26 with slide switch 21, sensitive snap switch 24, light emitting diode 22 and button cells 27 mounted thereon. Button cells 27 are secured to the circuit board 26 by means of screw 23 and cells fixing plate 25, the assembled circuit diagram as shown in FIG. 4. What is required explaining here is that SW2 in FIG. 4 is the slide switch 21 for the cells, SW1 is the sensitive snap switch 24 and LED is the light emitting diode, this is the most ordinary series circuit. Its working principle is that when SW2 is turned on, the button cell 27 starts to supply power and the sensitive snap switch 24 (SW1) in the glittering ring worn on the finger in response to the jumping and swaying of people intermittently connects with the power supply to make the light emitting diode 22 emit a glittering light.

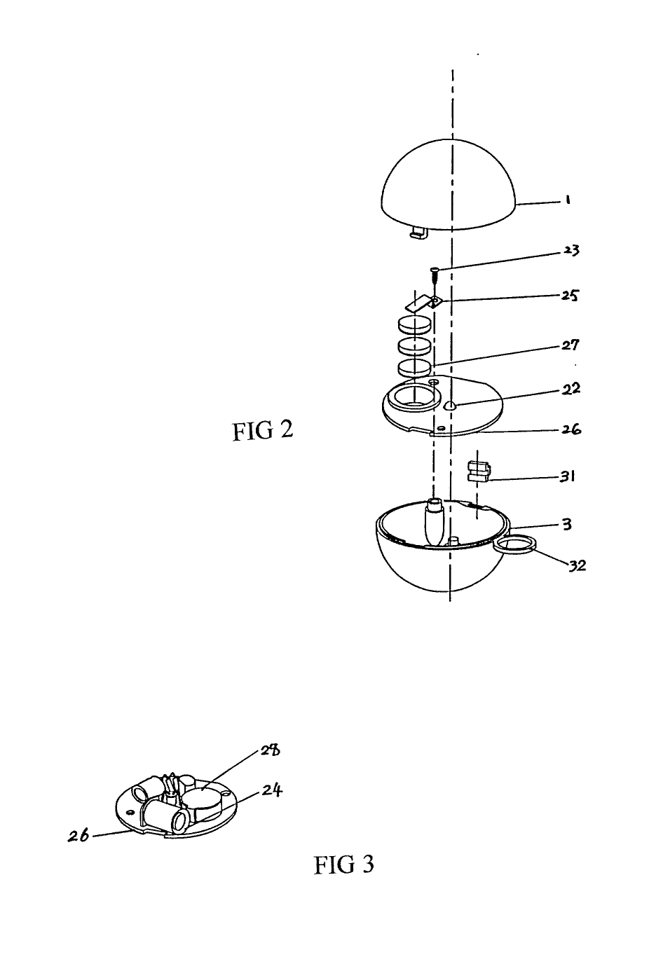

FIG. 2 and FIG. 3 are an exploded perspective diagram of the glittering neck pendant and a perspective diagram of an assembly of the inner works respectively. The glittering neck pendant comprises a shell body A 1 and a shell body B 3 encompassing the inner works 2. Inner works 2 comprises a circuit board 26 with a sensitive snap switch 24, a light emitting diode 22, and a few button cells 27 mounted thereon. The wiring for the mounting can either be as shown in FIG. 4 or as shown in FIG. 5. When wired as in FIG. 5, it should be added to the circuit a capacitor C1, resistors R1, R2 and a triode Q1, the parameters of which are indicated in the diagram. People having some knowledge in electricity can all do this wiring work. Here R1, C1, R2 and Q1 form a delay circuit. The working principle is that in response to the jumping or swaying of people, the sensitive snap switch instantly connects with the power source and once the power source is got through, the capacitor C1 is being charged by the cells 27, at the same time, the power source triggers via R1 the break-over of Q1 to make the light emitting diode emit a light. When SW1 breaks off, C1 supplies power to R1 and Q1 to keep the light emitting diode emit a light. With the falling of potential at the two ends of C1, the light emitting diode will gradually dim down and die out after 3-4 seconds.

As shell body A 1 and shell body B 3 are made of transparent frosted colloid, when the light emitting diode glows, it will emit a soft light and reflect on the whole sphere body, just like a ball of light very brilliant and dazzling.

The same principle and construction also apply to such artificial jewelry as bracelet, earring, brooch and headwear to form a glittering artificial jewelry. It will be unnecessary described here in details.

The glittering artificial jewelry of the present invention can be worn on one's person, when he or she is to participate in activities in dancing hall, restaurant, night club, bar and family party. With the movements of human body, the jewelry will emit a glittering light, forming a truly dynamic feeling of dazzling brightness and creating a lively atmosphere full of vitality.

1. A glittering artificial jewelry, characterized in that the shell of the jewelry encompasses a set of inner works (2) fixed in it, said works (2) comprising a circuit board with button cells, sensitive snap switch (24) and light emitting diode (22) mounted thereon and connected by wiring.

2. The glittering artificial jewelry, according to claim 1, characterized in that the circuit of the inner works (2) further include a slide switch (21).

3. The glittering artificial jewelry according to claim 1, characterized in that the circuit of the inner works (2) further include a delay circuit composed of resistor R1, capacitor C1, resistor R2 and triode Q1.

4. The glittering artificial jewelry according to claim 1, characterized in that said two shell bodies (1, 3) are linked by an inlaid Q-shaped removable or fixed hinge joint (31), the removable hinge joint being made of polystyrene material.

5. The glittering artificial jewelry according to claim 2, characterized in that said shell body A (1) is the top shell having a window (11) for the light-emitting diode on it, and shell body B (3) is the base shell having a ring (32) for being worn on the finger.

6. The glittering artificial jewelry according to claim 3, characterized in that said shell body A (1) and shell body B (3) are each a semi-shell body made of transparent frosted colloid.
